(19) United States
(12) Patent Application Publication
(10) Pub. No.: US 2026/0001424 A1
(43) Pub. Date: Jan. 1, 2026

(54) ELECTRICAL PROPULSION CHAIN FOR AN AIRCRAFT AND METHOD FOR CHARGING A BATTERY OF AN AIRCRAFT

(71) Applicant: SAFRAN ELECTRICAL & POWER, Blagnac Cedex (FR)

(72) Inventor: Vincent Chaperon, Moissy-Cramayel (FR)

(73) Assignee: SAFRAN ELECTRICAL & POWER, Blagnac Cedex (FR)

(21) Appl. No.: 18/880,693

(22) PCT Filed: Jul. 3, 2023
(86) PCT No.: PCT/FR2023/051011

§ 371 Date: Jan. 2, 2025

(30) Foreign Application Priority Data
Jul. 8, 2022 (FR) 2207018

(51) Int. Cl. B60L 53/24; B60L 50/60; B64D 35/021

(52) U.S. Cl. CPC B60L 53/24; B60L 50/60; B64D 35/021; B60L 2200/10; B60L 2210/30; B60L 2210/42; B60L 2240/50; B60L 2240/526

(57) ABSTRACT

The device for charging a battery of an aircraft comprises a reversible electrical power converter comprising a power inlet configured to be connected to the battery and a power outlet configured to be connected to a propulsion rotary electric machine driving a propeller of the aircraft in such a way that the power converter transfers electrical energy between the electric machine and the battery. The charging device also comprises a means for deactivating the propeller, the means being configured to prevent the rotation of the propeller and a parking socket connected between the charging contactor and the power outlet.

### TECHNICAL FIELD OF THE INVENTION

The invention relates to electrical aircraft propulsion systems, and more particularly devices for charging propulsion batteries and a battery charging method.

The invention further relates to a propulsion chain including such devices and an aircraft including such a propulsion chain.

### STATE OF PRIOR ART

Climate change is a major concern for many legislative and regulatory bodies throughout the world. Indeed, various restrictions on carbon emissions have been, are or will be adopted by various states. In particular, an ambitious standard applies both to new types of aeroplanes and those already in service, requiring the implementation of technological solutions in order to make them compliant with current regulations. Civil aviation has been working for several years now to make its contribution to the fight against climate change.

Technological research efforts have already led to significant improvements in the environmental performance of aeroplanes. The Applicant takes account of the impacting factors in all the design and development phases to obtain aeronautical components and products that consume less energy, are more environmentally friendly and whose integration and use in civil aviation have moderate environmental consequences with the purpose of improving the energy efficiency of aeroplanes.

As a result, the Applicant is constantly working to reduce its negative climate impact by using virtuous development and manufacturing methods and processes that minimise greenhouse gas emissions as much as possible to reduce the environmental footprint of its business.

This sustained research and development work focuses on new generations of aeroplane engines, lighter aircraft, especially lighter on-board equipment, the development of the use of electric technologies to ensure propulsion.

An electrically propelled aircraft comprises at least one electric motor driving a pusher propeller, at least one battery storing the electrical energy required to power the motor, and a power converter supplying the motor with AC voltage from a DC voltage delivered by the battery.

Charging the battery is performed when the aircraft is parked on the ground.

To this end, a ground unit providing an AC voltage is connected to the aircraft to charge the battery.

However, since the ground unit delivers a generally three-phase AC voltage, it is necessary to convert said voltage into a DC voltage to charge the battery.

It is known to implement a power converter in the ground unit to transform the AC voltage delivered by the ground unit into a DC voltage charging the battery.

However, it is necessary to develop a new ground unit architecture and to add a communication module between the ground unit and a battery charging management module of the battery implemented in the aircraft in order to regulate the charging of the battery.

It is also known to install a power converter in the aircraft to transform the AC voltage delivered by the ground unit into a DC voltage that charges the battery.

However, the implementation of a power converter and wiring harnesses supplying said power converter with three-phase voltage increase the weight of the aircraft, resulting in an increase in the aircraft's energy consumption, the power converter being dedicated exclusively to charging the battery.

### DISCLOSURE OF THE INVENTION

The purpose of the invention is to overcome all or some of these drawbacks.

To do this, the invention is the result of technological research aiming at most significantly improving the performance of aeroplanes and, accordingly, contributes to reducing the environmental impact of aeroplanes. For this, the invention relates a device for charging a battery for an aircraft and thus includes a reversible electrical power converter including a power input configured to be connected to the battery and a power output configured to be connected to a propulsion electric rotary machine driving a pusher propeller of the aircraft in such a way that the power converter transfers electrical energy between the electric machine and the battery.

The charging device further comprises a means for deactivating the pusher propeller configured to prevent rotation of the pusher propeller, and a ground connection connected to the power output.

The charging device enables the batteries of an aircraft to be charged from a ground unit known from the state of the art without implementing a power converter dedicated to charging the batteries in the aircraft so as not to increase the weight of the aircraft.

Charging the batteries implements a power converter already present in the aircraft to control a propulsion rotary machine of the aircraft.

It is also provided an electrical propulsion chain for an aircraft including a charging device as previously defined, a propulsion electric rotary machine configured to drive a pusher propeller of the aircraft, an electrical distribution device, and a battery, the electrical distribution device including a supply line including an input connected to the battery and an output connected to the power input of the converter, and wherein the means for deactivating the pusher propeller comprises a charging contactor connecting the power output of the converter to the electric rotary machine.

Preferably, the power converter comprises a first reversible conversion module connecting the power input to the power output and a second conversion module connecting a second power input to a second power output, the conversion modules being independent of each other, the electrical distribution device including a second electrical supply line including an input connected to the battery and an output connected to the second power input of the converter, the electric rotary machine comprising two redundant sets of stator coils, a first set of stator coils being connected to the charging contactor and the second set of stator coils being connected to the second power output of the converter.

Alternatively, the electrical propulsion chain for an aircraft comprises a charging device as previously defined, a propulsion electric rotary machine including a shaft configured to drive a pusher propeller of the aircraft, an electrical distribution device, and a battery. the electrical distribution device including an electrical supply line including an input connected to the battery and an output connected to the power input of the converter, and wherein the means for deactivating the pusher propeller comprises a clutch configured to disengage the pusher propeller from a shaft of the electric rotary machine to prevent rotation of the pusher propeller.

Preferably, the power converter comprises a first reversible conversion module connecting the power input to the power output and a second conversion module connecting a second power input to a second power output, the conversion modules being independent of each other, the electrical distribution device including a second electrical supply line including an input connected to the battery and an output connected to the second power input of the converter, the electric rotary machine comprising two redundant sets of stator coils, a first set of stator coils being connected to the power output and the second set of stator coils being connected to the second power output of the converter.

Advantageously, each electrical supply line comprises an electrical supply bus connected to the input of said supply line by a first contactor and connected to the output of said supply line by a second contactor, a first voltage sensor measuring a voltage between said input and the first contactor, a second voltage sensor measuring a voltage between the second contactor and the converter, and a control circuit configured to control the converter and the first and second contactors from the values measured by the first and second voltage sensors.

Preferably, the electrical propulsion chain further includes a redistribution contactor connecting the electrical supply bus of the electrical supply line to the electrical supply bus of the second electrical supply line, the control circuit being further configured to control the redistribution contactor.

Advantageously, the control circuit is further configured to control a ground unit supplying the ground connection when the pusher propeller is prevented from rotating.

Preferably, the electrical propulsion chain includes a second propulsion electric rotary machine, a second power converter, a second battery, the electrical distribution device including a third electrical supply line including an input connected to the second battery and an output connected to an input of the second power converter, the distribution device further including a distribution contactor connecting the electrical supply bus of the supply line to the electrical supply bus of the third electrical supply line, the control circuit being configured to control the distribution contactor.

It is also provided an aircraft including an electrical propulsion chain as previously defined and as many propulsion nacelles as there are propulsion electric rotary machines, each electric machine being disposed in a different nacelle, the means for deactivating the pusher propeller and the ground connection being disposed in one of the nacelles.

The ground connection disposed in one of the aircraft's nacelles, for example in the bottom part of the nacelle, eliminates the charging harness connecting the ground connection to the distribution device, further reducing the aircraft's weight.

Furthermore, a method for charging an aircraft battery comprising a reversible electrical power converter including a power input connected to the battery and a power output connected to a propulsion electric rotary machine of the aircraft in such a way that the power converter transfers electrical energy between the electric machine and the battery, which is particularly advantageous for the purpose of reducing the environmental impact of aeroplanes, is provided.

The method comprises activating a means for deactivating the pusher propeller to prevent rotation of the pusher propeller and supplying a ground connection connected to the power output when the pusher propeller is prevented from rotating in such a way that the power converter transfers electrical energy from the ground connection to the battery.

Preferably, the aircraft comprises a second propulsion electric rotary machine, a second power converter, a second battery, and an electrical distribution device including a supply line comprising an input connected to the battery and an output connected to the power input of the converter, a second supply line comprising an input connected to the second battery and an output connected to a power input of the second converter, and a distribution contactor, each supply line comprising an electrical supply bus connected to the input of said supply line by a first contactor and connected to the output of said supply line by a second contactor, a first voltage sensor measuring a voltage between said input and the first contactor, and a second voltage sensor measuring a voltage between the second contactor and the converter, the distribution contactor connecting the electrical supply bus of the first supply line to the supply bus of the second electrical supply line, the method further comprising closing the second contactor of the supply line and the redistribution contactor, opening the second contactor of the second supply line, and controlling the power converter from the values measured by the first and second current and voltage sensors of the supply line and the second supply line in such a way that the power converter transfers electrical energy from the ground connection to the second battery.

### BRIEF DESCRIPTION OF THE DRAWINGS

Further purposes, characteristics and advantages of the invention will appear upon reading the following description, given only as a non-limiting example, and made with reference to the appended drawings in which:

FIG. 1 schematically illustrates an aircraft according to the invention;

FIG. 2 schematically illustrates an example embodiment of the electrical distribution device according to the invention;

FIG. 3 schematically illustrates a first example implementation of a charging device according to the invention;

FIG. 4 schematically illustrates a second example implementation of the charging device according to the invention, and

FIG. 5 schematically illustrates another example embodiment of the charging device.

### DETAILED DISCLOSURE OF AT LEAST ONE EMBODIMENT

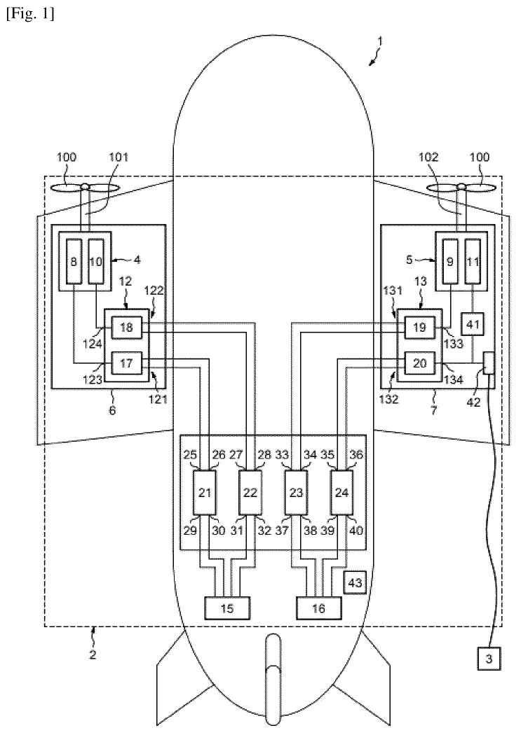

Reference is made to FIG. 1 which schematically illustrates an aircraft 1 comprising an electrical propulsion chain 2 connected to a ground unit 3.

The propulsion chain 2 comprises two multiphase propulsion electric rotary machines 4,5 each disposed in a nacelle 6, 7 on either side of a longitudinal axis of the aircraft 1 and including respective shafts 101, 102 each fitted with a propeller 100 to propel the aircraft 1.

A first rotary machine 4 is disposed in a first nacelle 6, and the second rotary machine 5 is disposed in the second nacelle 7.

For example, the machines 4, 5 are of the three-phase type.

For example, the aircraft 1 is an aeroplane.

Alternatively, the aircraft 1 may comprise more than two electric rotary machines 4, 5 disposed in equal numbers on either side the longitudinal axis of the aircraft 1.

According to still another alternative, the aircraft 1 may comprise a single electric rotary machine.

The aircraft 1 may also comprise at least one turboprop or turbojet engine driven by a fuel-burning turbomachine, so that the aircraft 1 has hybrid propulsion.

Each electric rotary machine 4,5 comprises a first set of stator coils 8, 9 and a second set of stator coils 10, 11.

The coils of each set of coils 8, 9, 10, 11 are, for example, connected together in a star configuration.

The propulsion chain 2 further comprises two power converters 12, 13, a distribution device 14, two batteries 15, 16 connected to the distribution device 14, and a control circuit 43 for controlling the propulsion chain 2.

The first converter 12 disposed in the first nacelle 6 is connected to the first electric rotary machine 4, and the second converter 13 disposed in the second nacelle 7 is connected to the second electric rotary machine 5.

The batteries 15, 16 are located, for example, in the bottom part of the aeroplane fuselage, in an additional fuselage, so that if one of the batteries 15, 16 releases a gas, the latter is ejected from the additional fuselage in a direction towards the ground in order to protect the aeroplane.

The location of the batteries 15, 16 makes it possible to simplify fuselage construction by avoiding the need to install chimneys in the fuselage to degas the batteries 15, 16.

Each converter 12, 13 comprises a first power input 121, 131, a second power input 122, 132, a first power output 123, 133, and a second power output 124, 134.

The distribution device 14 comprises as many identical electrical supply lines 21, 22, 23, 24 as there are power inputs 121, 122, 131, 132, each supply line 21, 22, 23, 24 being connected to a different power input 121, 122, 131, 132.

The first power input 121 of the first converter 12 is connected to output terminals 25, 26 of a first supply line 21, and the second power input 122 of the first converter 12 is connected to output terminals 27, 28 of a second supply line 22.

The first three-phase power output 123 of the first converter 12 is connected to the first set of stator coils 8 of the first rotary machine 4, and the second three-phase power output 124 of the first converter 12 is connected to the second set of stator coils 10 of the first rotary machine 4.

The first converter 12 comprises two independent conversion modules 17, 18 so that if one of the conversion modules 17, 18 fails the other conversion module 18, 17 continues to operate optimally.

The conversion modules 17, 18 are each made from semi-conductors, for example diodes and transistors.

A first conversion module 17 connects the first power input 121 to the first power output 123, and the second conversion module 18 connects the second power input 122 to the second power output 124.

Each conversion module 17, 18 receives a DC voltage at the power input 121, 122 and delivers a three-phase voltage system at the power output 124, 123 to supply and control the first machine 4.

Input terminals 29, 30, 31, 32 of the first and second supply lines 21, 22 are connected to the first battery 15.

The first and second supply lines 21, 22 supply DC voltage to the conversion modules 17, 18 from the first battery 15.

The sets of stator coils 8, 11 are each supplied by a supply circuit including a conversion module 17, 18 of the first converter 12 and the first and second supply lines 21, 22.

The supply circuits enable the rotary machine 4 to be supplied redundantly in order to compensate for a failure in one of the supply circuits.

The first power input 131 of the second converter 13 is connected to output terminals 33, 34 of a third supply line 23, and the second power input 132 of the second converter 13 is connected to output terminals 35, 36 of the fourth supply line 24.

Input terminals 37, 38, 39, 30 of the third and fourth supply lines 23, 24 are connected to the second battery 16.

The first three-phase power output 133 of the second converter 13 is connected to the first set of stator coils 9 of the second rotary machine 5.

The second three-phase power output 133 of the second converter 13 is connected to the second set of stator coils 11 of the second rotary machine 5 through a charging contactor 41.

Furthermore, a ground connection 42 is connected between the charging contactor 41 and the second power output 134.

The charging contactor 41 and the ground connection 42 are disposed in the nacelle 7 housing the second machine 5.

The ground connection 42 is connected to a power output of the ground unit 3 in such a way that the ground unit 3 supplies the ground connection 42 with electrical energy, the ground unit delivering, for example, a three-phase voltage system.

When the charging contactor 41 is open, all the phases of the second set of stator coils 11 of the second machine 5 are isolated from the ground connection 42 in such a way that the ground unit 3 supplies exclusively the second converter 13.

Since the second set of stator coils 11 of the second machine 5 is not supplied, the shaft 102 of said machine is not driven. Since the propeller 100 connected to the shaft 102 is not rotating, operators working on the second nacelle 7 are not likely to be injured by the propeller.

The control circuit 43 controls the first and second converters 12, 13, the supply lines 21, 22, 23, 24, and the charging contactor 41, and comprises, for example, a redundant processing unit.

The supply lines 21, 22, 23, 24 may further be connected to each other by redistribution and distribution contactors not represented in this figure.

When the aeroplane is flying, the second converter 13 supplied by a DC voltage at the power inputs 131, 132 delivers a three-phase voltage system at the power outputs 133, 134 to supply and control the second machine 4.

The first power output 133 supplies the first set of coils 9.

The charging contactor 41 is closed in such a way that the second power output 134 supplies the second set of coils 11.

The third and fourth supply lines 23, 24 supply DC voltage to the second converter 13 from the second battery 16.

The second reversible converter 13 comprises a conversion module 19 connecting the first power input 131 to the first power output 133, and a reversible conversion module 20 connecting the second power input 132 to the second power output 134.

The second reversible converter 13, the charging contactor 41 and the ground connection 42 form a charging device.

When the aeroplane is on the ground, as represented in FIG. 1, the ground unit 3 is connected to the ground connection 42 and the charging contactor 41 is opened by the control circuit 43 so that the second power output 134 and the ground connection 42 are not electrically connected to the second set of coils 11.

In flight, the sets of stator coils 9, 11 are each supplied by a supply circuit including a conversion module 19, 20 of the second converter 13 and the third and fourth supply lines 23, 24.

The supply circuits enable the rotary machine 5 to be supplied redundantly to compensate for a failure in one of the supply circuits.

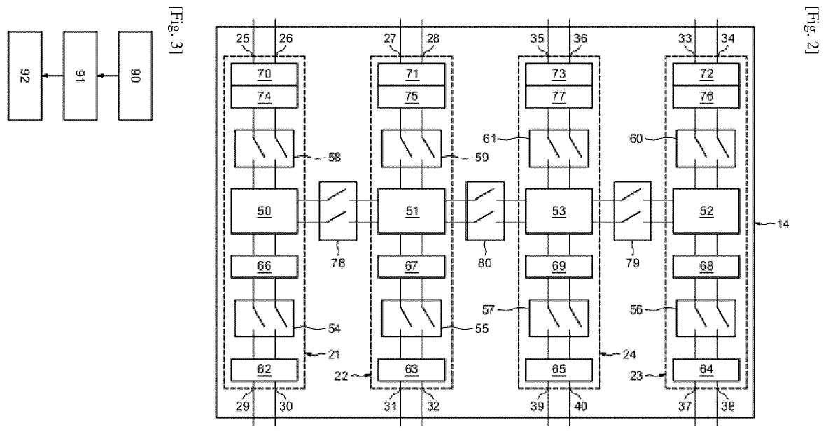

FIG. 2 illustrates an example embodiment of the distribution device 14 comprising the supply lines 21, 22, 23, 24.

Each supply line 21, 22, 23, 24 comprises an electrical supply bus 50, 51, 52, 53 connected to the input terminals 29, 30, 31, 32, 37, 38, 39, 40 forming the input of said line by a first contactor 54, 55, 56, 57.

Each supply line 21, 22, 23, 24 comprises a second contactor 58, 59, 60, 61 connecting the bus 50, 51, 52, 53 to the output terminals 25, 26, 27, 28, 33, 34, 35, 36 forming the output of said line.

Each supply line 21, 22, 23, 24 further comprises a first voltage sensor 62, 63, 64, 65 measuring a voltage between the input of said line and the first contactor 54, 55, 56, 57, and a second voltage sensor 70, 71, 72, 73 measuring a voltage between the second contactor 58, 59, 60, 61 and the converter 12, 13 connected to said line.

Each supply line 21, 22, 23, 24 may further comprise a first current sensor 66, 67, 68, 69 measuring a current between the first contactor 54, 55, 56, 57 and the bus 50, 51, 52, 53, and a second current sensor 74, 75, 76, 77 measuring a current between the second contactor 58, 59, 60, 61 and the converter 12, 13 connected to said line.

The distribution device 14 may further comprise two redistribution contactors 78, 79.

A first redistribution contactor 78 connects the buses 50, 51 of the first and second lines 21, 22 to each other, and the second redistribution contactor 79 connects the buses 52, 53 of the third and fourth lines 23, 24 to each other.

Each redistribution contactor 78, 79 ensures the supply of the two sets of coils 8, 10, 9, 11 of the machine 4, 5 by a single supply line.

The distribution device 14 may further comprise a distribution contactor 80 connecting the bus 51 of the second line 22 to the bus 53 of the fourth line 24 connected to the reversible conversion module 20.

The converters 12, 13, the first and second contactors 54, 55, 56, 57, 58, 59, 60, 61, the redistribution contactors 78, 79, and the distribution contactor 80 are controlled by the control circuit 43 from the values measured by the first and second current and voltage sensors 62 to 77.

FIG. 3 schematically illustrates a first example implementation of the charging device to charge the second battery 16.

It is assumed that the ground unit 3 is connected to the ground connection 42, that the first and second contactors 54 to 61 of each of the lines 21, 22, 23, 24 and the charging contactor 41 are closed, that the redistribution contactors 78, 79 and the distribution contactors 80 are open, and that the converters 12, 13 are switched off (not transferring electrical energy between their power inputs and outputs).

During a step 90, the control circuit 43 opens the charging contactor 41.

During a charging step 91, when the charging contactor 41 is open, the control circuit 43 controls the reversible conversion module 20 of the second converter 13 in such a way that the converter 13 transfers electrical energy from the ground connection 42 into the second battery 16.

The control circuit 43 controls the reversible conversion module 20 so that the difference in the voltages measured by the first and second voltage sensors 65, 73 of the fourth line 24 is equal to a predetermined threshold voltage, the voltage measured by the first sensor being lower than the voltage measured by the second sensor 73 so that the second battery 16 stores the electrical energy transferred by the second converter 13 while limiting the current draw of the second battery 16 during charging.

When the value measured by the first voltage sensor 65 is equal to a predetermined charging value, the second battery is assumed to be charged. The control circuit 43 controls the second converter 13 so as to stop charging the second battery 16.

During the charging step 91, the control circuit 43 reads the current values measured by the first and second current sensors 69, 77 in order to detect a failure.

The control circuit 43 compares the current values measured with predetermined alert thresholds.

If one of the current values measured is greater than the alert threshold associated with said value, during a step 92, the control circuit 43 controls the reversible conversion module 20 so that the voltage read by the first voltage sensor 65 is greater than the voltage read by the second voltage sensor 73.

The second battery 16 delivers electrical energy in order to prevent thermal runaway of the second battery 16, and then the control circuit 43 opens at least one of the first and second contactors 57, 61 of the fourth line 24.

Alternatively, the control circuit 43 communicates with control means of the ground unit 3.

The control circuit 43 transmits a setpoint value of voltage delivered by the ground unit 3 to the control means.

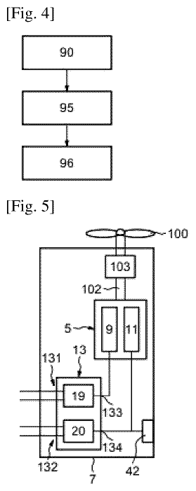

FIG. 4 schematically illustrates a second example implementation of the charging device.

In this implementation, the charging device charges the first battery 15.

It is assumed that the ground unit 3 is connected to the ground connection 42, that the first and second contactors 54 to 61 of each of the lines 21, 22, 23, 24 and the charging contactor 41 are closed, that the redistribution contactors 78, 79 and the distribution contactors 80 are open, and that the converters 12, 13 are switched off (not transferring electrical energy between their power inputs and outputs).

Step 90 is repeated.

And then, during a step 95, the control circuit 43 closes the distribution contactor 80 so that the buses 51, 53 of the second and fourth lines 22, 24 are connected to each other, opens the first contactor 57 of the fourth line 24 and the second contactor 59 of the second line 22.

During a charging step 96, when the charging contactor 41 is open and the distribution contactor 80 is closed, the first contactor 57 of the fourth line 24 and the second contactor 59 of the second line 22 are open, and the control circuit 43 controls the reversible conversion module 20 of the second converter 13 in such a way that the converter 13 transfers electrical energy from the ground connection 42 to the first battery 15.

The control circuit 43 controls the reversible conversion module 20 so that the difference in the voltages measured by the second voltage sensor 73 of the fourth line 24 and the first voltage sensor 63 of the second line 22 is equal to a predetermined threshold voltage, the voltage measured by the first sensor 63 being lower than the voltage measured by the second sensor 73 so that the first battery 15 stores the electrical energy transferred by the second converter 13 while limiting the current draw of the first battery 15 during charging.

The control circuit 3 reads the current values measured by the first current sensor 67 of the second line 22 and the second current sensor 77 of the fourth line 24 in order to detect a failure as described previously.

Alternatively, the first and second batteries 15, 16 are charged simultaneously by the converter 13 after the first switch 57 on the fourth line 24 is closed.

When the aircraft is on the ground, the first and second batteries 15, 16 can be charged sequentially by the charging device or simultaneously.

The charging device enables the batteries in the aircraft 1 to be charged from a ground unit known from the state of the art without implementing a power converter dedicated to charging the batteries in the aircraft 1 so as not to increase the weight of the aircraft.

Charging the batteries implements a power converter already present in the aircraft to control a propulsion rotary machine of the aircraft.

Furthermore, since the ground connection is disposed in one of the nacelles of the aircraft, for example in the bottom part of the nacelle, the charging harness connecting the ground connection to the distribution device is eliminated compared with a charging device known from the state of the art, making it possible to still further reduce the weight of the aircraft and simplify the routing of the said harness.

The charging contactor 41 forms a means for deactivating the pusher propeller to prevent rotation of the pusher propeller 100 when charging at least one of the batteries 15, 16.

FIG. 5 schematically illustrates another example embodiment of the charging device.

In this embodiment, the means for deactivating the pusher propeller comprises a clutch 103 connecting the shaft 102 of the second electric rotary machine 5 to the pusher propeller 100.

When the means for deactivating the pusher propeller comprises the clutch 103, the control circuit 43 controls the clutch 103 so that the shaft 102 is uncoupled from the propeller 100 to prevent rotation of the pusher propeller 100.

When the propeller is uncoupled from the shaft 102, the ground connection 42 is supplied by the ground unit and the control circuit 43 controls the reversible conversion module 20 of the second converter 13 as described previously.

All the phases of the second set of stator coils 11 of the second machine 5 are supplied by the second converter 13 so that the shaft 102 is rotationally driven.

The second machine 5 rotates at no load since the propeller is uncoupled from the shaft 102.

Since the second machine 5 rotates at no load, it consumes a reduced amount of energy.

Since the propeller is not rotating, operators working on the second nacelle 7 are not likely to be injured by the propeller.

1. An electrical propulsion chain for an aircraft including a device for charging a battery, a propulsion electric rotary machine configured to drive a pusher propeller of the aircraft, an electrical distribution device , and a battery,
the charging device comprising a reversible electrical power converter including a power input configured to be connected to the battery and a power output connected to the propulsion electric rotary machine in such a way that the power converter transfers electrical energy between the electric machine and the battery,
the charging device further comprising a means for deactivating the pusher propeller configured to prevent rotation of the pusher propeller, and a ground connection connected to the power output,
the electrical distribution device including an electrical supply line including an input connected to the battery and an output connected to the power input of the converter,
wherein,
the propulsion chain includes a second propulsion electric rotary machine, a second power converter, a second battery, the electrical distribution device including a third electrical supply line comprising an input connected to the second battery and an output connected to an input of the second power converter,
each electrical supply line comprising an electrical supply bus connected to the input of said supply line by a first contactor and connected to the output of said supply line by a second contactor, a first voltage sensor measuring a voltage between said input and the first contactor, a second voltage sensor measuring a voltage between the second contactor and the converter , and a control circuit configured to control the converter and the first and second contactors from the values measured by the first and second voltage sensors,
the distribution device further including a distribution contactor connecting the electrical supply bus of the supply line to the electrical supply bus of the third electrical supply line , the control circuit being configured to control the distribution contactor.

2. The electrical propulsion chain for an aircraft according to claim 1, wherein the means for deactivating the pusher propeller comprises a charging contactor connecting the power output of the converter to the electric rotary machine.

3. The electrical propulsion chain according to claim 2, wherein the power converter comprises a first reversible conversion module connecting the power input to the power output and a second reversible conversion module connecting a second power input to a second power output , the conversion modules being independent of each other, the electrical distribution device including a second electrical supply line including an input connected to the battery and an output connected to the second power input of the converter, the electric rotary machine comprising two redundant sets of stator coils, a first set of stator coils being connected to the charging contactor and the second set of stator coils being connected to the second power output of the converter.

4. The electrical propulsion chain for an aircraft according to claim 1, wherein the means for deactivating the pusher propeller comprises a clutch configured to disengage the pusher propeller from a shaft of the electric rotary machine to prevent rotation of the pusher propeller.

5. The electrical propulsion chain according to claim 4, wherein the power converter comprises a first reversible conversion module connecting the power input to the power output and a second conversion module connecting a second power input to a second power output, the conversion modules being independent of each other, the electrical distribution device including a second electrical supply line including an input connected to the battery and an output connected to the second power input of the converter, the electric rotary machine comprising two redundant sets of stator coils, a first set of stator coils being connected to the power output and the second set of stator coils being connected to the second power output of the converter.

6. The electrical propulsion chain according to claim 3, further including a redistribution contactor connecting the electrical supply bus of the electrical supply line to the electrical supply bus of the second electrical supply line, the control circuit being further configured to control the redistribution contactor.

7. The electrical propulsion chain according to claim 1, wherein the control circuit is further configured to control a ground unit supplying the ground connection when the pusher propeller is prevented from rotating.

8. An aircraft including an electrical propulsion chain according to claim 1 and as many propulsion nacelles as there are propulsion electric rotary machines, each electric machine being disposed in a different nacelle, the means for deactivating the pusher propeller and the ground connection being disposed in one of the nacelles.

9. A method for charging a battery of an aircraft comprising a reversible electrical power converter including a power input connected to the battery and a power output connected to a propulsion electric rotary machine of the aircraft in such a way that the power converter transfers electrical energy between the electric machine and the battery, a second propulsion electric rotary machine, a second power converter, a second battery, and an electrical distribution device including a supply line comprising an input connected to the battery and an output connected to the power input of the converter, a second supply line comprising an input connected to the second battery and an output connected to a power input of the second converter, and a distribution contactor, each supply line comprising an electrical supply bus connected to the input of said supply line by a first contactor and connected to the output of said supply line by a second contactor, a first voltage sensor measuring a voltage between said input and the first contactor, and a second voltage sensor measuring a voltage between the second contactor and the converter, a first current sensor measuring a current between the first contactor and the bus and a second current sensor measuring a current between the second contactor and the converter connected to said supply line, the distribution contactor connecting the electrical supply bus of the first electrical supply line to the electrical supply bus of the second electrical supply line, the method comprises activating a means for deactivating the pusher propeller to prevent rotation of the pusher propeller and supplying a ground connection connected to the power output when the pusher propeller is prevented from rotating in such a way that the power converter transfers electrical energy from the ground connection to the battery, closing the second contactor of the supply line and the redistribution contactor, opening the second contactor of the second supply line, and controlling the power converter from the values measured by the first and second current and voltage sensors of the supply line and the second supply line in such a way that the power converter transfers electrical energy from the ground connection to the second battery.
